(19) United States
(12) Patent Application Publication
(10) Pub. No.: US 2015/0307335 A1
(43) Pub. Date: Oct. 29, 2015

(54) HAND OPERATED VEHICLE LIFTING APPARATUS

(71) Applicant: Martin Raymond Beebe, Huntington Beach, CA (US)

(72) Inventor: Martin Raymond Beebe, Huntington Beach, CA (US)

(21) Appl. No.: 14/696,234

(22) Filed: Apr. 24, 2015

Related U.S. Application Data
(60) Provisional application No. 61/995,961, filed on Apr. 25, 2014.

(51) Int. Cl. B66F 5/04; B66F 5/02

(52) U.S. Cl. CPC B66F 5/04; B66F 5/02

(57) ABSTRACT

A hand operated vehicle lifting apparatus. The hand operated vehicle lifting apparatus preferably lifts a vehicle by engaging with the wheels of the vehicle. Preferably, the hand operated vehicle lifting apparatus comprises a wheel engagement portion and a hinge for storage.

### CROSS-REFERENCE TO RELATED APPLICATIONS

This Application claims the benefit of U.S. Provisional Patent Application No. 61/995,961, filed on Apr. 25, 2014, titled “Novel method of lift using hydraulic pressure and embodiment of apparatus for wheeled conveyance”, by inventor Martin R. Beebe, the contents of which are expressly incorporated herein by this reference and to which priority is claimed.

### FIELD OF USE

The present disclosure relates generally to hand jacks. More specifically, this disclosure relates to vehicle lifting hydraulic hand operated floor jacks that engage with the wheels of the vehicle.

### BACKGROUND

A vehicle lifting apparatus or jack may be categorized based on the type of force it employs, such as mechanical or hydraulic. A mechanical jack, for example, may utilize a screw mechanism to apply force to the jack body to lift a vehicle. The short thread distance of the screw provides a mechanical advantage that allows heavy loads to be raised with moderate effort. However, one disadvantage is that the screw must be rotated numerous times to achieve a small amount of lift.

A hydraulic jack may utilize an incompressible fluid that is forced into a cylinder by a pump plunger. When the plunger pulls back, it draws the fluid out of the reservoir through a suction check valve and into a pump chamber. When the plunger moves forward, it pushes the fluid through a discharge check valve and into a cylinder. The suction valve ball is within the chamber and opens with each draw of the plunger. The discharge valve ball is outside the chamber and opens only when the fluid is pushed into the cylinder. At this moment, the suction ball within the chamber is forced shut, thereby building fluid pressure inside the cylinder.

Both mechanical and hydraulic jacks, however, do not include a stable support structure that may engage an area beneath the vehicle for lifting. These structures also usually cannot support the weight of the vehicle and may cause damage to the vehicle. For example, if the user attempts to lift the vehicle by placing the jack under the bumper, damage will likely occur to the bumper.

Additionally, many jacks may often be the wrong size for certain elevational requirements for vehicles. Accomplishing the desired elevation of one end of the vehicle at a certain angle, for example, makes small jacks unwieldy, because small jacks typically only have a single contact point. Thus, as the contact point rotates due to the elevational difference between the front end and back end of the vehicle, the contact point angle with the jack may become unstable. Even merely achieving the necessary elevation may also exceed a jack's lifting capability.

Typically, lifting devices may include a safety warning that provides that the user should not perform any work on a lifted vehicle solely relying on the lift effort of the original lifting device, due to the chance that it might fail or become off balance. Accordingly, once lifted, the user typically uses a jack stand or other supporting device to provide stability during maintenance or storage. Importantly, because most modern cars may have a unibody structure, there are only a few specific locations on that unibody structure, which might be engaged by standard lifting devices. Lifting the vehicle by engaging in a different location may damage the vehicle. But, when a vehicle is lifted by engaging in the few specific locations available, that location is not available for a hand-off to the jack stand.

Thus, there is a need for a vehicle lifting apparatus with a support structure configured to engage with the wheels of a vehicle for elevating the entire front end or back end of a vehicle. This will preferably provide force distribution in multiple areas of the vehicle, rather than a single contact point of the vehicle frame. There is also a need for a vehicle lifting apparatus that is configured so as to make available for a jack stand the few specific locations on a vehicle that can engage a jack or jack stand.

### SUMMARY OF EMBODIMENTS

To minimize the limitations in the cited references, and to minimize other limitations that will become apparent upon reading and understanding the present specification, the vehicle lifting apparatus disclosed herein preferably uses a wheel fork lifting arm assembly to efficiently elevate the front or rear wheels of a stationary vehicle in order to perform maintenance or repairs.

One embodiment of the vehicle lifting apparatus may comprise: a floor jack base; and a lifting assembly. The lifting assembly may be affixed to a top portion of the floor jack base; wherein the lifting assembly comprises: a center manifold; one or more lifting arms; two wheel fork assemblies; one or more brace forks; and one or more guide forks. The lifting assembly may be configured to engage with one or more wheels of a vehicle, such that floor jack base is able to lift the vehicle. The two wheel fork assemblies may be configured to be removeably connected to the one or more lifting arms. The floor jack base may be selected from the group of floor jack bases consisting of a pneumatic floor jack and a mechanical floor jack. The one or more lifting arms may be two lifting arms; wherein the two lifting arms may be hingedly connected to opposite sides of the center manifold, such that the two lifting arms have at least an extended position and a storage position. The lifting assembly may further comprise at least two fork pins and at least two hinge fix pins. The one or more brace forks may be two brace forks. The one or more guide forks may be two guide forks. Each of the two lifting arms may comprise a fork connector. The at least two fork pins may be configured to securely and removeably connect the two fork assemblies to the fork connectors. The at least two hinge fix pins may be configured to fix the two lifting arms into the extended position and the storage position.

Another embodiment of the vehicle lifting apparatus comprises: a floor jack base; and a lifting assembly; wherein the lifting assembly may be affixed to a top portion of the floor jack base; wherein the lifting assembly comprises: a center manifold; two lifting arms, wherein each of the two lifting arms comprises a fork connector; two wheel fork assemblies; a right side brace fork; a left side brace fork; a right side guide fork; a left side guide fork; two fork pins; and two hinge fix pins. The lifting apparatus may further comprise the features of: wherein the two wheel fork assemblies may be configured to be removeably connected to the one or more lifting arms via the two fork pins and the two fork connectors; wherein the two lifting arms may be hingedly connected to opposite sides of the center manifold, such that the two lifting arms have at least an extended position and a storage position; wherein the at least two hinge fix pins may be configured to fix the two lifting arms into the extended position and the storage position; and wherein the right side brace fork and the right side guide fork may be configured to engage with a first wheel of a vehicle and wherein the left side brace fork and the left side guide fork may be configured to engage with a second wheel of the vehicle, such that when the lifting assembly may be raised by the floor jack base the vehicle is raised. The floor jack base may be selected from the group of floor jack bases consisting of a pneumatic floor jack and a mechanical floor jack.

Another embodiment of the vehicle lifting apparatus may comprise: a floor jack base; and a lifting assembly; wherein the lifting assembly may be affixed to a top portion of the floor jack base; wherein the lifting assembly comprises: a center manifold; two lifting arms, two wheel fork assemblies. The two wheel fork assemblies may be retractable and extendable along the one or more lifting arms. When the two wheel fork assemblies may be in a retracted position the lifting assembly may be configured to be positioned between two wheels of a vehicle and wherein the two wheel fork assemblies may be extended such that the two wheel fork assemblies engage with two wheels of a vehicle, such that floor jack base is able to lift the vehicle. The two lifting arms each may have a wheel fork channel guide and a wheel fork assembly lead screw. The each of the two wheel fork assemblies may be configured to be positioned along one of the two lifting arms via the wheel fork channel guide and the wheel fork assembly lead screw. The floor jack base may be selected from the group of floor jack bases consisting of a pneumatic floor jack and a mechanical floor jack. The two lifting arms may be hingedly connected to opposite sides of the center manifold, such that the two lifting arms have at least an extended position and a storage position. The lifting assemblies further comprise two brace forks and two guide forks. The two brace forks and the two guide forks may be configured to engage with the wheels of the vehicle. The wheel fork assemblies may be connected to the lifting arms in a perpendicular or parallel manner.

Another embodiment of the vehicle lifting apparatus comprises: a weldment chassis; a hydraulic actuated piston; casters; a clevis plate; pivoting control arms; a torsion spring; and casters. The weldment chassis may be connected to and driven by a hydraulic actuated piston; wherein the weldment chassis may be mounted to casters for positioning by the user; wherein the weldment chassis may be integrated with the clevis plate. The pivoting control arms may be in moveable but continuous contact with the clevis plate by a connecting rod to create a hinged relationship between the weldment chassis and pivoting control arms; wherein a torsion spring may be integrated within the pivoting control arms and the clevis plate for positioning of the pivoting control arms; wherein the pivoting control arms have an integral extension proceeding out laterally to a designated length.

In another embodiment, the vehicle lifting apparatus may comprise: a primary lift wedge; a secondary lift wedge; a connecting arm; and a lifting connector; The primary lift wedge may consist of a frictional binding planar surface between the wheels of a vehicle; wherein the primary lift wedge may consist of a frictional binding planar surface between the ground; wherein the primary lift wedge may have a geometric profile substantially triangular in shape; wherein the primary lift wedge may have a geometric profile substantially elliptical in shape; wherein the primary lift wedge may have a frictional binding surface being the same surface representing the circumference of the elliptical geometric profile; wherein the span of the primary lift wedge geometric profile may be twelve (12) inches. A lifting connector may be attached to the primary lift wedge by thermal bonding; wherein a lifting connector may be attached to the primary lift wedge by a mechanical fastener; wherein the shape of the lifting connector may be complementary to the shape of the pivoting control arm extension; wherein the lifting connector may fit around the pivoting control arm extension; wherein a pin is placed in the lifting connector and passed through a hole correspondingly located on the pivoting control arm extension to assure alignment between the lifting connector and the pivoting control arm extension. A secondary lift wedge may be substantially similar to the primary lift wedge; wherein a secondary lift wedge may have a substantially similar geometric profile as the primary lift wedge without the lifting connector; wherein a secondary lift wedge may have a substantially different geometric profile that embodies the same frictional binding planar surface properties as the primary lift wedge. The telescoping connecting arm may be configured to slide or cause to slide into itself; wherein the telescoping connecting arm may be substantially in the shape of a square tube; wherein the telescoping connecting arm may be substantially in the shape of a flat plate; wherein a graduated locking mechanism may be attached between the telescoping connecting arms to secures adjustments between the primary left wedge and the secondary lift wedge; wherein a telescoping connecting arm may be attached to each lift wedge by thermal bonding; wherein a telescoping connecting arm may be attached to each lift wedge by a mechanical fastener.

It is an object to provide a more efficient vehicle lifting apparatus.

The vehicle lifting apparatus may comprise a lifting mechanism that may slide underneath of a front or rear portion of a vehicle and engage either the two front tires or two rear tires of the vehicle.

The present vehicle lifting apparatus may comprise removable vehicle wheel fork assemblies, each of which may further comprise a wheel fork channel guide, wheel fork arm, brace chock, and guide chock. The brace chock and guide chock may be perpendicularly extended from the wheel fork arm to impact against the bottom side of a vehicle wheel. The brace chock and guide chock may also be spaced apart to define a gap with the vehicle in order for the wheel to rest between the gap. The vehicle wheel fork assembly may be attached to the lifting arm assembly by a lead screw.

The present vehicle lifting apparatus may allow the load of a vehicle to bear on the tires and suspension and may leave available the corresponding specified lift points under the vehicle to place a jack stand The jack stand may provide a more stable and secure position off the ground in order to perform maintenance, repairs, or storage.

It is an object of the present vehicle lift apparatus to overcome the limitations of the prior art.

Other features and advantages inherent in the vehicle lifting apparatus claimed and disclosed will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of one embodiment of the vehicle lifting apparatus when it is in a raised position.

FIG. 2 is an illustration of a top perspective view of one embodiment of the vehicle lifting apparatus when it is in a raised position.

FIG. 3 is an illustration of one embodiment of a lifting assembly unattached to the rest of the vehicle lifting apparatus.

FIG. 4 is an illustration of one embodiment of a center manifold with the wheel fork assemblies removed and in a storage position.

FIG. 5 is an illustration of an exploded view of one embodiment of a lifting assembly unattached to the rest of the vehicle lifting apparatus.

FIG. 6 is an illustration of a side view of another embodiment of the vehicle lifting apparatus and shows the use of a mechanical lifting mechanism.

FIG. 7 is an illustration of a top plan view of another embodiment of the vehicle lifting apparatus and shows that the lifting arms may hinge vertically.

FIG. 8 is an illustration of a side view of another embodiment of the vehicle lifting apparatus and shows the apparatus in a lowered and storage position.

FIG. 9 is an illustration of a side view of another embodiment of a floor jack base.

### DETAILED DESCRIPTION OF THE ILLUSTRATIVE EMBODIMENTS

In the following detailed description, numerous specific details are set forth in order to provide a thorough understanding of various aspects of one or more embodiments. However, the one or more embodiments may be practiced without some or all of these specific details. In other instances, well-known methods, procedures, and/or components have not been described in detail so as not to unnecessarily obscure aspects of embodiments.

While multiple embodiments are disclosed, still other embodiments will become apparent to those skilled in the art from the following detailed description. As will be realized, these embodiments are capable of modifications in various obvious aspects, all without departing from the spirit and scope of protection. Accordingly, the screen shots, figures, and the detailed descriptions thereof, are to be regarded as illustrative in nature and not restrictive. Also, the reference or non-reference to a particular embodiment of the invention shall not be interpreted to limit the scope of protection.

In the following description, certain terminology is used to describe certain features of one or more embodiments. For instance, the term “vehicle” refers to any automotive vehicle what has at least one axle, preferably two, wherein the at least one axle may have two or more wheels.

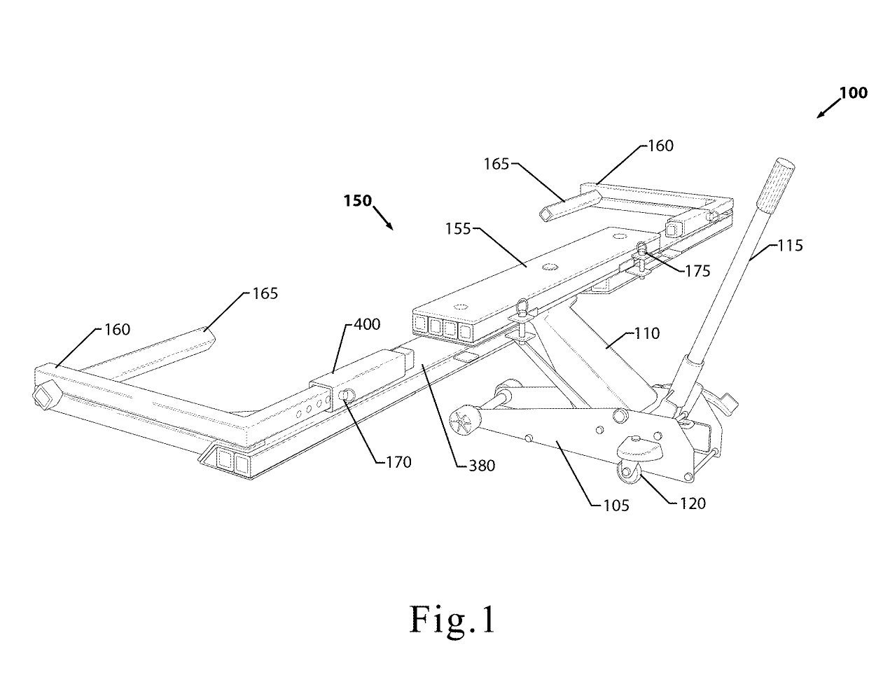

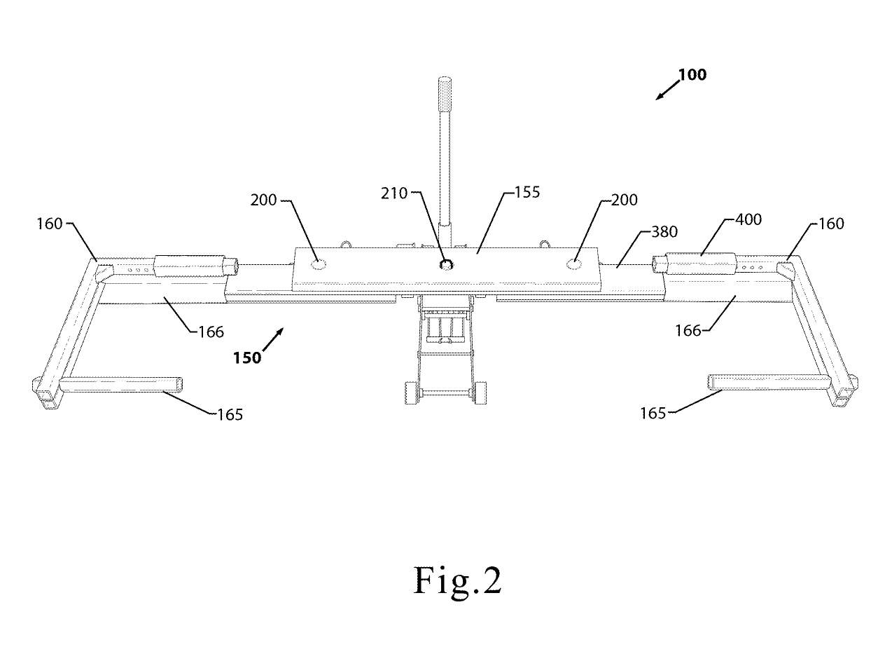

FIG. 1 is an illustration of a perspective view of one embodiment of the vehicle lifting apparatus when it is in a raised position. As shown in FIG. 1, one embodiment of the vehicle lifting apparatus 100 may comprise: a handle arm with pneumatic manifold conduit 115, a base chassis 105, casters 120, lift arm 110, and lifting assembly 150. FIG. 1 shows how the lifting assembly 150 is a vehicle engagement portion and may comprise a center manifold 155, lifting arms 380, wheel fork assemblies 160, brace forks 165, guide forks 166 (shown in FIG. 2), fork connectors 400, fork pins 170, and hinge fix pins 175. As shown in FIG. 1, casters 120 may be fixed to the front end and rear end of the vehicle lifting apparatus 100 to provide ease of movement of the vehicle lifting apparatus 100. FIG. 1 also shows that a handle arm with a pneumatic manifold conduit 115 may be fixed to the rear end of the vehicle lifting apparatus 100, preferably at an orientation that provides ease of control when raising a vehicle during pumping. The vehicle lifting apparatus 100 shown in FIG. 1 is pneumatic powered but may be mechanical or electrically powered. The vehicle lifting apparatus 100 may also be hand powered and may be used in a home or commercial garage environment. The lifting assembly 150 may be configured to be connected to existing, well-known in the art hand powered floor jacks by removing the vehicle engagement portion, typically referred to as a saddle, cup, or saddle pad, and replacing that portion with the lifting assembly 150. Alternatively, the lifting assembly 150 may be connected directly to the saddle. Without the lifting assembly being connected, the existing floor jack is referred to as the floor jack base. The floor jack base may be powered by various ways, including, but not limited to, pneumatic, hydraulic, mechanical, and/or electrical. The floor jack base may be a car jack, a floor jack, a house jack, a garage jack, a screw jack, a farm jack, a bottle jack, a strand jack, a whisky jack, or any type of jack that is configured to lift vehicles.

FIG. 2 is an illustration of a top perspective view of one embodiment of the vehicle lifting apparatus when it is in a raised position. As shown in FIG. 2, the vehicle lifting apparatus 100 may comprise a lifting assembly 150, which may comprise a center manifold 155, lifting arms 380, wheel fork assemblies 160, brace forks 165, guide forks 166, fork connectors 400, lifting assembly pin 210, and hinges 200. As shown in FIG. 2, the lifting assembly pin 210 may connect the lifting assembly 150 to the vehicle lifting apparatus 100, or more particularly to the lift arm 110. Hinges 200 may be used to position the lifting assembly 150 from an extended position to a storage position. Although the hinges 200 show the lifting assembly 150 hinging on a horizontal plane, the hinge may operate vertically or diagonally or at any angle. FIG. 2 also shows that the brace forks 165 may be angled such that a flat surface is preferably towards the vehicle wheel that is engaged. Although FIG. 2 shows the brace forks 165 as being square in their cross-section, the brace forks may also be constructed in various shapes such as substantially flat, round, cylindrical, triangular, or any shape that may support a wheel or tire of a vehicle. FIG. 2 shows that the guide forks 166 may be in the general shape of a chock and may present a flat angled surface for engaging a tire. The guide forks 166 may also be constructed in any shape, including, but not limited to, round, cylindrical, square, triangular, substantially flat or any shape that may support a wheel or tire of a vehicle.

FIG. 2 also shows that the wheel fork assemblies 160 may removeably and matingly slide into and out of, and fixedly connect to the fork connectors 400, which may preferably be part of, or welded to, the lifting arm 380. The brace forks 165 are preferably part of the wheel fork assemblies 160. The guide forks 166 as shown are preferably part of both the lifting arms 380 and the wheel fork assemblies 160. Alternatively, the guide forks 166 may be part of only the lifting arms 380 or the wheel fork assemblies 160.

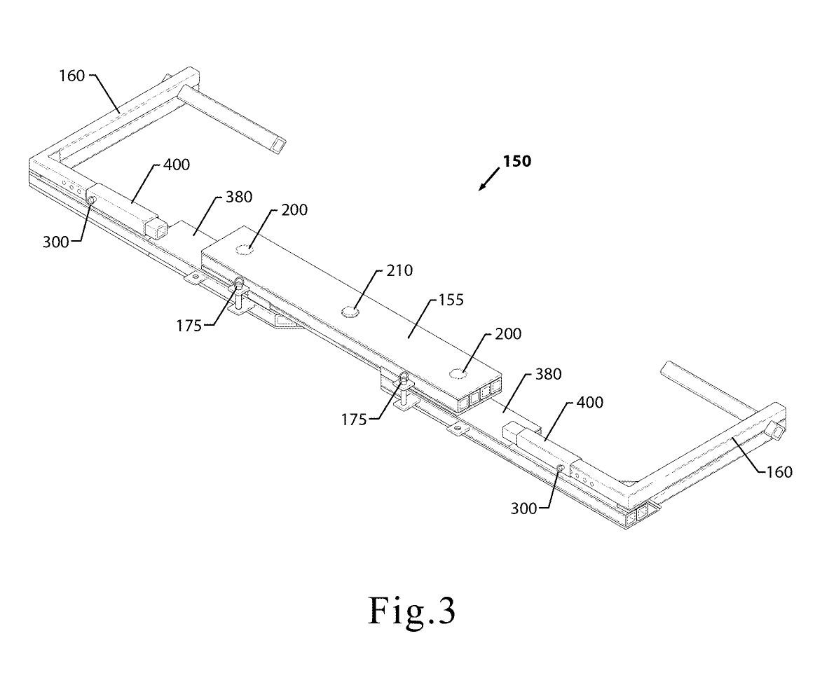

FIG. 3 is an illustration of one embodiment of a lifting assembly unattached to the rest of the vehicle lifting apparatus. As shown in FIG. 3, one embodiment of the lifting assembly 150 may comprise: a center manifold 155, lifting arms 380, wheel fork assemblies 160, brace forks 165, guide forks 166, fork connectors 400, lifting assembly pin 210, hinge fix pins 175, and hinges 200. FIG. 2 shows that the lifting assembly pin 210 preferably connects the lifting assembly 150 to the vehicle lifting apparatus 100, and more particularly to the lift arm 110. Hinges 200 may be used to position the lifting assembly 150 from an extended position to a storage position.

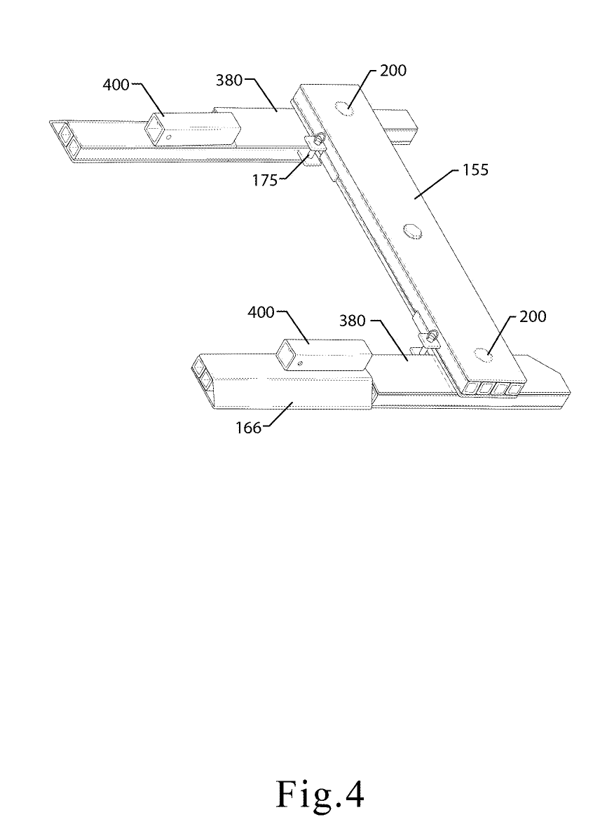

FIG. 4 is an illustration of one embodiment of a center manifold with the wheel fork assemblies removed and in a storage position. One embodiment of the center manifold 160 may be hingedly connected to the lifting arms 380, which may be in an extended position, as shown in FIG. 3, or a hinged position (hinging at hinge 200), as shown in FIG. 4. FIG. 4 also shows that the fork connectors 400, which may receive and connect to the wheel fork assemblies, shown in FIG. 3, may be part of, or fixedly connected to, the lifting arm 380. The hinge fix pins 175 may be used to lock the lifting assembly 150 into an extended position or a hinged position. Although a manual hinge fix pins device is shown in FIG. 4, any hinge locking device may be used to keep the lifting assembly 150 in an extended, hinged, storage, or intermediate position.

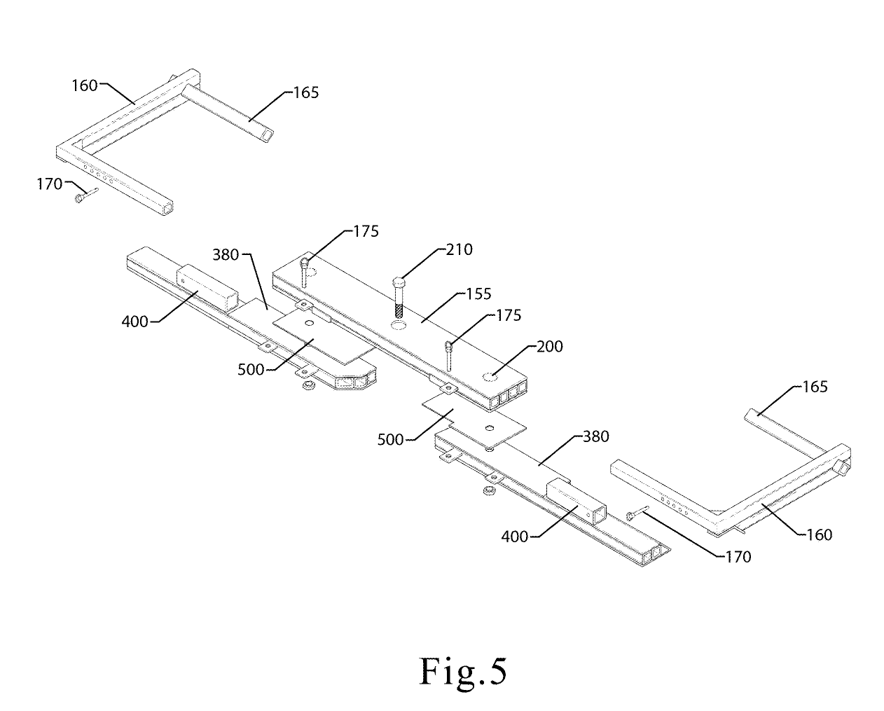

FIG. 5 is an illustration of an exploded view of one embodiment of a lifting assembly unattached to the rest of the vehicle lifting apparatus. As shown in FIG. 5, one embodiment of the lifting assembly 150, may comprise a center manifold 155, lifting arms 380, wheel fork assemblies 160, brace forks 165, guide forks 166, fork connectors 400, lifting assembly pin 210, hinge fix pins 175, and hinges 200. FIG. 5 shows that the lifting assembly pin 210 may connect the lifting assembly 150 to the vehicle lifting apparatus 100, or more particularly to the lift arm 110. Hinges 200 may also be used to position the lifting assembly 150 from an extended position to a storage position.

FIG. 5 shows that the fork pins 170 may be used to removeably connect the wheel fork assemblies 160 to the fork connectors 400. The wheel fork assemblies 160 may be disconnected from the lifting arm 380, and the vehicle lifting device may then be positioned, such that the guide forks 166 contact or are substantially near two opposing tires of a vehicle. The wheel fork assemblies 160 may then be interconnected with the lifting arm 380, and more specifically with the fork connectors 400. Once the vehicle lifting assembly 150 matingly engages with the tires of a vehicle, the engaged end of the vehicle may be hoisted or lifted by the vehicle lifting apparatus 100 by manually or automatically engaging the lifting mechanism. Preferably, the vehicle lifting apparatus 100 is a pneumatic hand jack, as shown in FIG. 1.

Preferably, the wheel fork assemblies 160 may be disconnected from the vehicle lifting apparatus 100 during storage.

FIG. 5 shows that the vehicle lifting assembly 150 may comprise one or more plastic sheets 500 that reduce the friction during the hinge action between the center manifold 155 and the lifting arms 380.

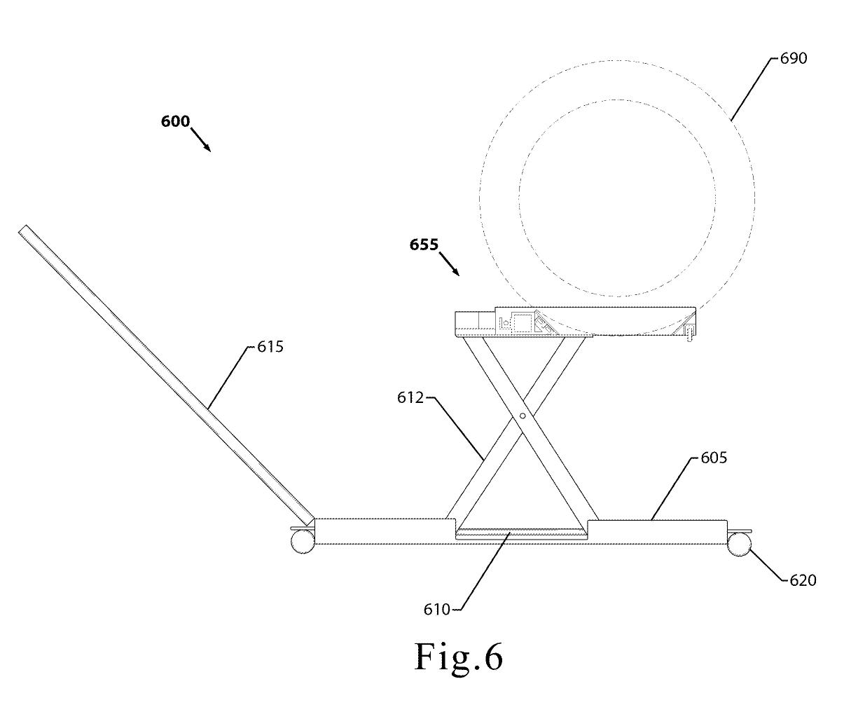

FIG. 6 is an illustration of a side view of another embodiment of the vehicle lifting apparatus and shows the use of a mechanical lifting mechanism. FIG. 6 shows that one embodiment of the vehicle lifting apparatus 600 may comprise: a handle arm with pneumatic manifold conduit 615, a base chassis 605, casters 620, and lifting assembly 655. FIG. 6 shows that the vehicle lifting apparatus 600 may also comprise a scissor hinge assembly 612, which may include a scissor hinge lead screw drive 610, such that the vehicle lifting apparatus 600 is a mechanical lifting device. The scissor hinge lead screw drive 610 may be used to activate the scissor hinge assembly 612 to raise (and/or lower) the lifting assembly 655. The vehicle lifting apparatus 600 may then be used to lift the wheels 690 of a vehicle.

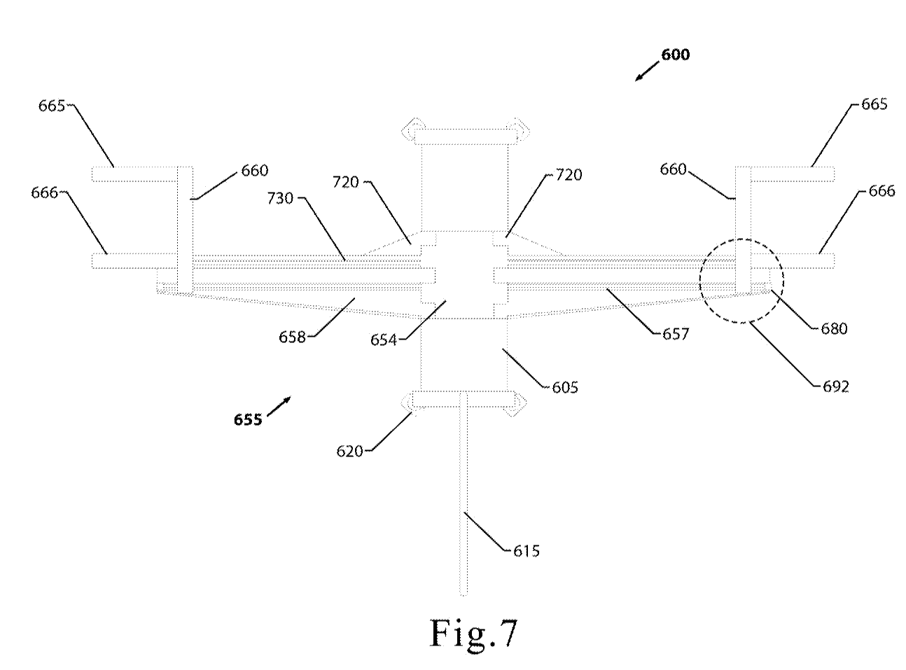

FIG. 7 is an illustration of a top plan view of another embodiment of the vehicle lifting apparatus and shows that the lifting arms may hinge vertically. FIG. 7 shows that another embodiment of the vehicle lifting apparatus 600 may comprise: a handle arm with pneumatic manifold conduit 615, a base chassis 605, casters 620, center manifold 654, and a lifting assembly 655. FIG. 6 shows that the lifting assembly 655 may comprise: lifting arms 658, wheel fork assemblies 660, brace forks 665, guide forks 666, lifting arm hinges 720, wheel fork assembly lead screws 657, and wheel fork channel guides 730. As shown in FIG. 7, the lifting assembly 655 may comprise a center manifold 654, which may preferably be hingedly connected to the lifting arms 658 via lifting arm hinges 720. In other embodiments lifting assembly 655 may be constructed without hinges. FIG. 7 shows the lifting assembly in an extended position and ready to engage with the wheels of a vehicle.

Each of the lifting arms 658 may further comprise a wheel fork channel guides 730, wheel fork assembly lead screws 657, and lead screw bearing blocks 680, which allows the wheel fork assemblies 660 to be moved back and forth along the lifting arms 658. In this manner, the wheel fork assemblies 660 may be retracted proximally toward the center manifold 654 via application of the wheel fork assembly lead screws 657, which are held in place by lead screw bearing blocks 680. Although a mechanical lead screw mechanism is shown in FIG. 7, the wheel fork assemblies 660 may be manually slid along the wheel fork channel guides 730. The wheel fork assemblies 660 may also be moved by other mechanical, electrical, or pneumatic mechanisms, so long as the wheel fork assemblies 660 may move, be moved, or be repositioned between a disengaged and engaged positions. When the wheel fork assemblies 660 are in a retracted position, the vehicle lifting apparatus 600 may be rolled under an end of a vehicle such that the lifting arms 658 are lined up with the wheels of the vehicle. The wheel fork assemblies 660 may then be moved distally such that they engage the wheels of the vehicle. The vehicle lifting apparatus 600 may preferably be in a lowered position during the initial engagement operations. Once the wheels are engaged, the vehicle lifting apparatus 600 raises the vehicle, positions one or more jack stands under the vehicle, and then lowers the vehicle onto the jack stands. When the user is ready to lower the vehicle the vehicle lifting apparatus 600 may preferably be in a raised position during this subsequent engagement operation. Once the wheels are engaged, the vehicle lifting apparatus 600 raises the vehicle off the jack stands, removes the jack stands and then lowers the vehicle to the ground.

The wheel fork assemblies 660 may be removable or permanently connected to the lifting arms 658. The wheel fork assemblies 660 may connect by engaging the lifting arms in a perpendicular or parallel manner.

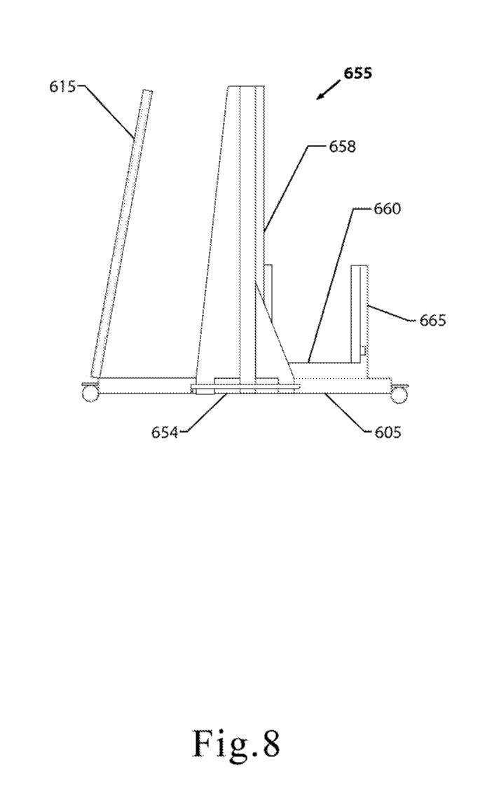

FIG. 8 is an illustration of a side view of another embodiment of the vehicle lifting apparatus and shows the apparatus in a lowered and storage position. FIG. 8 shows that another embodiment of the vehicle lifting apparatus 600, may comprise: a handle arm with pneumatic manifold conduit 615, a base chassis 605, casters 620, center manifold 654, lifting arm hinges 720, a lifting assembly 655, lifting arms 658, wheel fork assemblies 660, and brace forks 665. FIG. 8 shows that when in storage, lifting arm assembly is as low as possible such that the vehicle lifting apparatus 600 may engage with the vehicle to be lifted. The wheel fork assemblies 660 are shown proximally retracted and in close proximity to the center manifold 654. The lifting arms 658 are shown hinged at hinges 720. In this manner, the vehicle lifting apparatus 600 may be streamlined for storage.

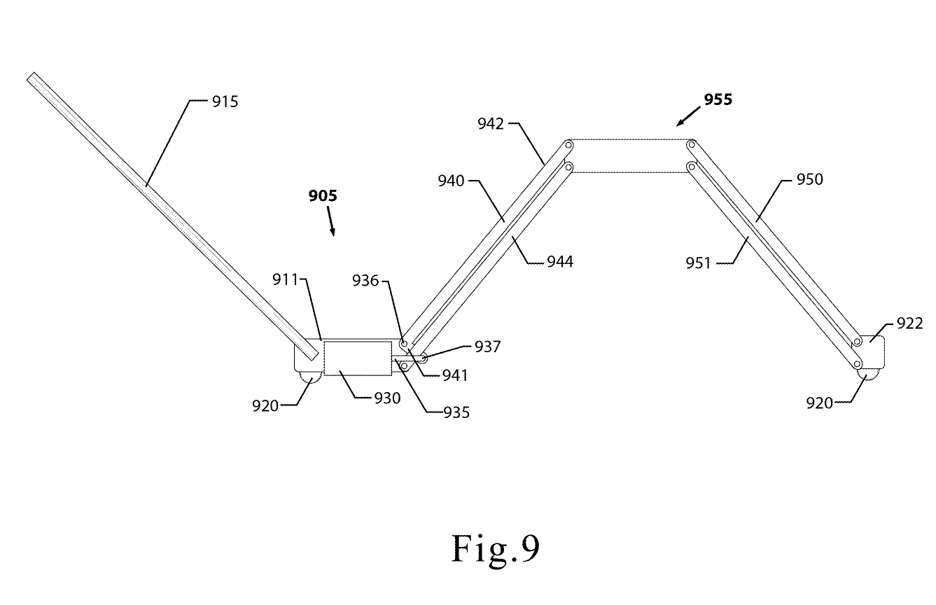

FIG. 9 is an illustration of a side view of another embodiment of a floor jack base for one embodiment of the vehicle lifting apparatus. FIG. 9 shows that the vehicle lifting apparatus 900 may comprise floor jack base 905 and lifting assembly 955. The floor jack base 905 may comprise a handle arm 915 with pneumatic or hydraulic manifold conduit 930, a piston 935, a base chassis 911, secondary chassis 922, casters 920, fulcrum 936, piston connection 937, primary lift arm 940, and supporting lift arms 944, 950, 951. FIG. 9 shows that primary lift arm 940 may be angled and attached to the base chassis at fulcrum 936 and attached to the piston 935 at piston connection 937. In this manner, as the handle 915 is pumped, the pneumatic or hydraulic manifold conduit 930 pushes piston 935 outward, which in turn causes the short portion 941 of the primary lift arm 940 to move outward, which causes the primary lift arm 940 to pivot on fulcrum 936, which causes the long portion 942 of the primary lift arm 940 to angle upward such that the lifting assembly 955 is raised. The supporting lift arms 944, 950, 951 provide additional support and secondary 922 moves towards the base chassis 911 during the lifting motion. To move the lifting assembly 955 downward, the user releases the pressure to cause the piston 935 to move back inward in a controlled manner.

The parts of the vehicle lifting apparatus 100, 600, 900 may be formed from any number of interconnected or welded parts. Alternatively, some of the parts may be part of the same forged piece. The parts of the vehicle lifting apparatus 100, 600, 900 is preferably constructed from strong materials, such as metals, aluminum, iron, steel, composites, and polymers. The various methods of manufacture may require different engineering, which may affect the final look of the embodiment.

Unless otherwise stated, all measurements, values, ratings, positions, magnitudes, sizes, locations, and other specifications which are set forth in this specification, including in the claims that follow, are approximate, not exact. They are intended to have a reasonable range which is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded as illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

I claim:

1. A vehicle lifting apparatus, comprising:
a floor jack base; and
a lifting assembly;
wherein said lifting assembly comprises:
a center manifold;
one or more lifting arms;
two wheel fork assemblies;
one or more brace forks; and
one or more guide forks; and
wherein said lifting assembly is configured to engage with one or more wheels of a vehicle, such that floor jack base is able to lift said vehicle.

2. The vehicle lifting apparatus of claim 1, wherein said two wheel fork assemblies are configured to be removeably connected to said one or more lifting arms.

3. The vehicle lifting apparatus of claim 1, wherein said floor jack base is selected from the group of floor jack bases consisting of a pneumatic floor jack and a mechanical floor jack.

4. The vehicle lifting apparatus of claim 1, wherein said one or more lifting arms are two lifting arms; and
wherein said two lifting arms are hingedly connected to opposite sides of said center manifold, such that said two lifting arms have at least an extended position and a storage position.

5. The vehicle lifting apparatus of claim 4, wherein said lifting assembly further comprises
at least two fork pins and at least two hinge fix pins;
wherein said one or more brace forks are two brace forks;
wherein said one or more guide forks are two guide forks; and
wherein each of said two lifting arms comprises a fork connector.

6. The vehicle lifting apparatus of claim 5, wherein said at least two fork pins are configured to securely and removeably connect said two fork assemblies to said fork connectors.

7. The vehicle lifting apparatus of claim 5, wherein said at least two hinge fix pins are configured to fix and secure said two lifting arms into said extended position and said storage position.

8. The vehicle lifting apparatus of claim 5, wherein said lifting assembly is affixed to a top portion of said floor jack base.

9. A vehicle lifting apparatus, comprising:
a floor jack base; and
a lifting assembly;
wherein said lifting assembly comprises:
a center manifold;
two lifting arms, wherein each of said two lifting arms comprises a fork connector;
two wheel fork assemblies;
a right side brace fork;
a left side brace fork;
a right side guide fork;
a left side guide fork;
two fork pins; and
two hinge fix pins;
wherein said two wheel fork assemblies are configured to be removeably connected to said one or more lifting arms via said two fork pins and said two fork connectors;
wherein said two lifting arms are hingedly connected to opposite sides of said center manifold and are configured to extend and retract, such that said two lifting arms have at least an extended position and a storage position;
wherein said at least two hinge fix pins are configured to fix and secure said two lifting arms into said extended position and said storage position; and
wherein said right side brace fork and said right side guide fork are configured to engage with a first wheel of a vehicle and wherein said left side brace fork and said left side guide fork are configured to engage with a second wheel of said vehicle, such that when said lifting assembly is raised by said floor jack base, said vehicle is raised.

10. The vehicle lifting apparatus of claim 9, wherein said floor jack base is selected from the group of floor jack bases consisting of a pneumatic floor jack and a mechanical floor jack.

11. The vehicle lifting apparatus of claim 9, wherein said lifting assembly is affixed to a top portion of said floor jack base;

12. A vehicle lifting apparatus, comprising:
a floor jack base; and
a lifting assembly;
wherein said lifting assembly is affixed to a top portion of said floor jack base;
wherein said lifting assembly comprises:
a center manifold;
two lifting arms,
two wheel fork assemblies;
wherein said two wheel fork assemblies are retractable and extendable along said one or more lifting arms;
wherein when said two wheel fork assemblies are in a retracted position, said lifting assembly is configured to be positioned between two wheels of a vehicle and wherein said two wheel fork assemblies are extended such that said two wheel fork assemblies engage with two wheels of a vehicle, such that floor jack base is able to lift said vehicle.

13. The vehicle lifting apparatus of claim 12, wherein said two lifting arms each have a wheel fork channel guide and a wheel fork assembly lead screw.

14. The vehicle lifting apparatus of claim 13, wherein said each of said two wheel fork assemblies is configured to be positioned along one of said two lifting arms via said wheel fork channel guide and said wheel fork assembly lead screw.

15. The vehicle lifting apparatus of claim 12, wherein said floor jack base is selected from the group of floor jack bases consisting of a pneumatic floor jack and a mechanical floor jack.

16. The vehicle lifting apparatus of claim 12, wherein said two lifting arms are hingedly connected to opposite sides of said center manifold, such that said two lifting arms have at least an extended position and a storage position.

17. The vehicle lifting apparatus of claim 12, wherein said lifting assemblies further comprise two brace forks and two guide forks.

18. The vehicle lifting apparatus of claim 17, wherein said two brace forks and said two guide forks are configured to engage with said wheels of said vehicle.

19. The vehicle lifting apparatus of claim 12, wherein said wheel fork assemblies are configured to connect to said two lifting arms in a perpendicular or parallel manner.

20. The vehicle lifting apparatus of claim 12, wherein said lifting assembly is affixed to a top portion of said floor jack base.
